(19) United States
(12) Patent Application Publication
(10) Pub. No.: US 2023/0176554 A1
(43) Pub. Date: Jun. 8, 2023

(54) SYSTEM AND METHOD FOR OPTIMIZING MULTIPLE AT LEAST PARTIALLY INTERLINKED PRODUCTION INSTALLATIONS AND/OR PROCESSES OF A METALLURGICAL INSTALLATION, IN PARTICULAR OVER THE ENTIRE LIFE AND/OR THE ENTIRE METALLURGICAL PROCESS CHAIN

(71) Applicant: SMS group GmbH, Düsseldorf (DE)

(72) Inventors: Christoph HÄUSLER, Duisburg (DE); André PESCHEN, Mönchengladbach (DE); Sebastian SCHULZ, Aachen (DE); David MASTERNAK, Mönchengladbach (DE)

(73) Assignee: SMS group GmbH, Düsseldorf (DE)

(21) Appl. No.: 17/999,839

(22) PCT Filed: Mar. 29, 2021
(86) PCT No.: PCT/EP2021/058082

§ 371 Date: Dec. 29, 2022

(30) Foreign Application Priority Data
May 25, 2020 (DE) 10 2020 206 476.8

(51) Int. Cl. G05B 19/418

(52) U.S. Cl. CPC G05B 19/41865; G05B 19/4185; G05B 19/41875

(57) ABSTRACT

In a system for optimizing production installations and/or processes of a metallurgical installation each production installation and/or process comprises a separate data management device. Entities of the metallurgical installation that are relevant for the respective part of the production installation and/or process are identifiable by local identifiers and the local identifiers can be used to retrieve data of separate data management devices. Within a central data management device each entity of the metallurgical installation has an associated global identifier. The applicable local identifiers of the separate data management devices are associated with the same entities of the metallurgical installation by the respective global identifier in the central data management device. Optimization involves at least some of the data from the separate data management devices being aggregated and evaluated by means of the global identifiers.

### TECHNICAL FIELD

The disclosure relates to a system for optimizing multiple at least partially interlinked production installations and/or processes of a metallurgical installation, in particular over the entire life and/or the entire metallurgical process chain. The disclosure further relates to a method for optimizing multiple at least partially interlinked production installations and/or processes of a metallurgical installation, in particular over the entire life and/or the entire metallurgical process chain, and to computer programs for carrying out the method in accordance with the disclosure, in particular by means of a system in accordance with the disclosure.

### BACKGROUND

A metallurgical process chain comprises multiple interdependent manufacturing processes, in particular from primary metallurgy through secondary metallurgy to primary forming and forming processes. In one or more processes, a semi-finished product such as pipe, rod, profile, sheet, billets, slabs or the like is produced from a raw material such as ore, scrap and the like. From this semi-finished product, a final product is manufactured in one or more subsequent processes, for example by the automotive industry, the aerospace industry, the construction industry, machine industry or the like. Numerous installations, machines and service providers are involved in the entire metallurgical process chain, and independent production installations and/or processes are required for each manufacturing process such as melting, smelting, sintering, pressing, drop forging, extrusion, deep drawing, alloying, refining, casting, hot rolling, cold rolling, heat treatment, electroplating, etc. Thereby, the individual production installations and/or processes may comprise associated subinstallations and/or subprocesses. Frequently, the different production facilities and/or processes of the metallurgical installation are spatially separated from one another, in particular when changing from primary metallurgy to secondary metallurgy or further to the primary forming and forming processes.

The individual production installations and/or processes including the associated subinstallations and/or subprocesses can be optimized with regard to different objectives, such as, for example, optimized process control, achieved product quality, minimal maintenance measures or comparable objectives. As part of the digital transformation of industrial processes, also known as Industry 4.0, data is recorded and digitally evaluated in this respect in the individual production installations and/or processes, including the associated subinstallations and/or subprocesses. For this purpose, the data recorded by sensors, for example, are stored in a data management device and evaluated by applications.

In order to optimize processes and production facilities in the sense of Industry 4.0 (increasing efficiency through the availability of information), the correlation of information is required. The correlation of information requires, on the one hand, that data records are technically available and, on the other hand, that they can be uniquely identified. The availability of data records is guaranteed in the prior art via application programming interfaces (APIs). In the prior art, the identifiability of data records within a single data management device is ensured by means of one-to-one identifiers, hereinafter referred to as identifiers. Beyond necessary conditions of identifiability and availability to correlate data, knowledge of the relationship between the data to be correlated is a sufficient condition.

However, the individual production installations and/or processes of a metallurgical installation including the associated subinstallations and/or subprocesses are usually operated independently of one another, wherein, if necessary, the starting product of a production installation and/or processes must be physically transported to a remote production installation and/or process in order to be further processed there. This is particularly the case when changing from primary metallurgy to secondary metallurgy or further to primary forming and forming processes. The production facilities and/or processes are operated by different users and may have been produced by different manufacturers.

The manufacturing process of a production installation of a metallurgical installation starts with sales and extends through design, procurement, manufacturing, and shipping, up to commissioning. Particularly in special installation engineering, the processes and data management devices that lead to the manufacture of the production installation are usually heterogeneous. The heterogeneity of the source processes or source data management devices, as the case may be, thus shapes the data management devices available for the operation and maintenance of the production facilities. From such created structures, an adapted structure must now always be generated separately and anew for each further use case, for example maintenance.

In addition to data origin, there is another effect that promotes heterogeneity in data architecture. Each available digital solution is tailored to the user's needs and thus reflects their individual view of the production installation. Thus, the database, which is mostly built using SQL databases, contains a hierarchical structure that is tailored to the needs of the respective user.

The consequence of both effects—historical data origin and different views—leading to the heterogeneity of the data architecture is not only the multitude of data records for one and the same entity, but basically the multitude of entities for one and the same unit.

The term entity is used in the following to refer to a physical unit for which data is available, for example a production installation, an assembly, a single part, a location, a customer, a spatial area (hall, area, room or the like), a produced good (coil, bar, slab or the like), or an abstract unit, for example a process, an event, an order, a work order, an error message, etc.

This makes it difficult to exchange data between the individual production installations and/or processes, in particular if these comprise subinstallations and/or subprocesses. For example, corresponding interfaces would have to be provided and the individual production installations and/or processes would have to have knowledge of the data structures of the other production installations and/or processes. For example, the identifiability of data records within a data management device is usually ensured via unique identifiers, whereas the unique identifiability of data records beyond the boundaries of a physical data management device is not ensured.

The necessary prerequisites, such as availability and identifiability of data records, and the sufficient prerequisite, such as relationship of data to an entity, for correlation of data are significantly complicated by the heterogeneity of data management devices from a purely data technology point of view, such that the effort required to create the basic technical prerequisites for correlation can hardly be justified economically from a commercial point of view. However, this hurdle does not exempt the operators of metallurgical installations from the need to remain competitive by correlating data and the resulting optimizations in operating costs, responsiveness and product quality, to name a few.

### SUMMARY

The disclosure is based on the object of providing an economically and technically optimized networking of individual digital solutions in order to profitably use holistic effects in the sense of emergence.

The object is achieved by a system for optimizing multiple at least partially interlinked production installations and/or processes of a metallurgical installation, in particular over the entire life and/or the entire metallurgical process chain,
wherein each production facility and/or each process can comprise respective associated subinstallations and/or subprocesses,
wherein each production facility and/or each process comprises a separate data management device and each sub-facility and/or subprocess can comprise an optional dedicated data management device,
wherein, in each separate data management device of the production installations and/or processes and the optional dedicated data management devices of the subinstallations and/or subprocesses, the entities of the metallurgical installation that are relevant for the respective part of the production installation and/or process and of the subinstallations and/or subprocesses are identifiable by local identifiers and the local identifiers can be used to retrieve the data of the separate data management devices and of the optional dedicated data management devices that are associated with the related entities of the metallurgical installation,
wherein the system for optimizing the multiple at least partially interlinked production installations and/or processes comprises a central data management device in which each entity of the metallurgical installation has an associated global identifier,
wherein the applicable local identifiers of the separate data management devices and of the optional dedicated data management devices that are associated with the same entities of the metallurgical installation are associated with the respective global identifier in the central data management device, and
wherein the optimization of the multiple at least partially interlinked production installations and/or processes involves at least some of the data from the separate data management devices and the optional dedicated data management devices being aggregated and evaluated by means of the global identifiers.

The separate data management devices of the production installations and/or processes, the dedicated data management devices of the subinstallations and/or subprocesses and/or the central data management device of the system can be designed as a database, database management system, data structure, data memory or the like. The data does not have to be persistent, but can also be calculated, created, retrieved, read, determined or the like at the time of data access.

The system is based on an aggregation and evaluation of all available data on the multiple production installations and/or processes of a metallurgical installation, including any subinstallations and/or subprocesses. For each production installation and/or for each process, recorded data are stored in a separate data management device. Furthermore, data recorded for each subinstallation and/or subprocess may be stored in an optional dedicated data management device. The separate data management devices and the optional dedicated data management devices may have different structures. Furthermore, the entities of the metallurgical installation relevant for the respective part of the production installation location and/or process and the subinstallations and/or subprocesses are identifiable by different local identifiers in the separate data management devices and the optional dedicated data management devices. The data of the separate data management devices and the optional dedicated data management devices assigned to the associated entities of the metallurgical installation can be retrieved via the different local identifiers.

Although the data is available and identifiable in the separate data management devices and the optional data management devices, it is only identifiable via the respective local identifiers. With the plurality of production installations and/or processes and possible subinstallations and/or subprocesses, each production installation and/or process would have to have detailed knowledge of the separate data management devices and optional dedicated data management devices of the other production installations and/or processes and subinstallations and/or subprocesses, but this is not economically feasible due to the complexity.

For aggregation and evaluation, the system provides a central data management device, in which each entity of the metallurgical installation has an associated global identifier. This global identifier is associated in the central data management device with the applicable local identifiers of the separate data management devices and the optional dedicated data management devices, which are associated with the same entities of the metallurgical installation. This also comprises a reference to the respective separate data management devices and the optional dedicated data management devices.

By means of the central data management device, it is easy to determine, by means of the global identifier, in which separate data management devices data on an entity of the metallurgical installation are stored. The references to the local identifiers of the separate data management devices and the optional dedicated data management devices can be used to retrieve the corresponding data from the separate data management devices and the optional dedicated data management devices. Based on the total retrieved data from the separate data management devices and the optional dedicated data management devices, the separate production facilities and/or processes of the metallurgical installation can be optimized by aggregating and evaluating the retrieved data.

For the aggregation and evaluation of the data, they must be available and identifiable, and their relationship to one another must be sufficiently known. Availability in the separate data management devices and the optional dedicated data management devices is ensured via appropriate interfaces, in particular programmable interfaces. Assuming that data always belongs to one entity, the data records associated with the entity can also be identified when the entity is identified. Since data on individual entities are available in multiple databases, but are marked with different identifiers in the respective databases, correlation of the data requires knowledge of all the different identifiers for one and the same entity in the databases concerned. This information—a list of all identifiers for an entity—is to be collected and made available centrally and once (single source of truth). This is achieved by the central data management device of the system.

The central data management device thus provides, in the first instance, the functionality of a register for identifiers relating to one and the same entity of the metallurgical installation in the separate data management devices and optional dedicated data management devices. In this regard, the central data management device has global identifiers to uniquely identify the entities of the metallurgical installation. As a consequence, the central data management device in the second instance provides a global identifier for each entity of the metallurgical installation, which combines all identifiers for one and the same entity from other data management devices (keyword: “golden record”).

Based on the global identifiers from the first and second instances, applications that use data records for entities from the dedicated separate (isolated) data management device may use a programming interface of the central data management device to determine which other separate data management devices and optional dedicated data management devices contain information on this specific entity and to determine the identifiers used in these other separate data management devices and optional dedicated data management devices. With knowledge of the identifiers for one and the same entity in other separate data management devices and optional dedicated data management devices, data records for this specific entity can be retrieved and used via the corresponding interfaces of just these other separate data management devices and optional dedicated data management devices. In the third instance, the central data management device or its interface, as the case may be, serves as the connecting element.

Based on a local and/or global identifier, the system can be used to determine which other local and/or global identifiers are attached to an entity.

According to one preferred variant, the separate data management devices and the optional dedicated data management devices comprise data on the entities of the metallurgical installation, in particular data relevant to the respective production installation and/or production process or the subinstallation and/or subprocess of the metallurgical installation. In particular, these data are aggregated and evaluated during optimization by the system.

In one variant, the optimization is carried out by a superordinate control system, for optimizing the overall balance of the metallurgical installation, in particular in the areas of maintenance, process control or product quality.

In accordance with a further variant, the optimization is carried out by one or more control systems operating independently of one another, for the optimization of a single production installation and/or a single process of the metallurgical installation, wherein at least partially data from the separate data management devices and the optional dedicated data management devices of the other independently operating production installations and/or processes and subinstallations and/or subprocesses are taken into account.

Furthermore, a combination of a superordinate control system with one or more independently operating control systems is also possible. Preferably, the areas of optimization differ in such a combination, for example the process control is optimized globally, while maintenance measures are optimized locally. However, many other combinations of optimizations are also possible.

According to one variant, the separate data management devices and/or optional dedicated data management devices may have at least partially different structures. The respective structures of the individual data management devices are of little importance, since, by means of the global data management device, the local identifiers of the separate and optional dedicated data management devices, which are sufficient for a data query from the separate data management devices and optional dedicated data management devices, can be determined in a simple manner.

In one variant, the separate data management devices and/or optional dedicated data management devices may contain at least partially data on the same entities of the metallurgical installation. By means of the global data management device, there can be a determination of which separate and/or optional dedicated data management devices data on an entity of the metallurgical installation are stored. Contrary to the prior art, this data can be identified by means of the central data management device and retrieved from the separate data management devices and optional dedicated data management devices for subsequent aggregation and evaluation during optimization.

In accordance with an advantageous variant, the global identifier of the central data management device replaces or supplements the local identifiers of the separate data management devices and/or optional dedicated data management devices. In such variant, the data from the separate data management devices and optional dedicated data management devices can be easily retrieved using the global identifier of the central data management device. This simplifies, for example, the retrieval of data from multiple data management devices, since the respective queries to the separate data management devices and optional data management devices do not have to contain the respective associated local identifiers, but may all contain the global identifier.

According to an expedient variant, information is stored in the central data management device, in which separate data management devices and/or optional dedicated data management devices data on individual entities of the metallurgical installation are stored. This simplifies the process of locating, retrieving, aggregating and evaluating data on entities in the metallurgical installation.

In a further expedient variant, the individual separate data management devices and/or optional separate data management devices comprise interfaces for exchanging data with one another.

In accordance with an advantageous variant, the central data management device additionally contains information on relationships between the entities of the metallurgical installation.

According to a particularly advantageous embodiment of this variant, the central data management device contains information on different types of relationships between the entities of the metallurgical installation, in particular on spatial, functional, process or comparable relationships. Entities may be related in various ways, for example spatially (is built into; consists of; is in the same space; . . . ), functionally (is fed by; is controlled by; is consumed by; . . . ) or in terms of process (melting, casting, rolling, . . . ), to name but a few.

In one expedient variant, the information stored in the central data management device on relationships between the entities of the metallurgical installation forms a network.

In accordance with an expedient variant, the central data management device maps the relationships between the entities of the metallurgical installation as a graph. For example, the central data management device is designed as a graph database for this purpose, or the graphs are generated at runtime. Thereby, a graph in the sense of the disclosure is a data structure that relates entities to one another via edges. Thus, in the variant, the local identifiers are related to one another by means of graphs via global identifiers. The graphs make it easy to map complex structures of the metallurgical installation. The entities of the metallurgical installation may have a multitude of relationships among themselves and form a complex network, but are still easily represented by the graphs. By means of the graphs, in particular, the local and/or global identifiers of subordinate and/or superordinate entities can also be determined.

In the individual separate data management devices and optional dedicated data management devices, the relationships between the entities of the metallurgical installation can be represented by the structure of the data management device. Since each separate data management device, possibly in combination with associated optional dedicated data management devices, covers a sub-aspect of the metallurgical installation, the structure of the sub-aspect can usually be represented by a hierarchy, i.e. an order based on superordination and subordination. This can be easily mapped using existing SQL databases. However, a more complex type of relationship, such as a network formed by a metallurgical installation, can only be represented to a limited extent by available SQL databases.

However, within the metallurgical installation, individual entities may assume different roles for different production installations and/or processes and/or different subinstallations and/or subprocesses, such that the central data management device must in principle be suitable for mapping a network of relationships between the entities of the metallurgical installation. This can be realized by using graphs, wherein the entities represent the nodes of the graphs and the connections between the nodes represent the relationships among the entities. If the information from the aforementioned instances 1-3 of the central data management device is now mapped by means of graphs, the condition of knowledge of relationships, which is sufficient for a correlation of data, can also be mapped via the central data management device in the fourth instance.

In accordance with an expedient variant, the central data management device is connected via a communication network to other components of the metallurgical installation, in particular the separate data management devices and/or optional dedicated data management devices. Since the individual components of the metallurgical installation, in particular the multiple production installations, can be spatially distributed, the communication network is designed as a supraregional network.

In an advantageous variant, the central data management device comprises a graphical user interface. This simplifies operation, administration, data sharing and the like.

According to a further variant, the system comprises an interface to an enterprise resource planning system (ERP system). Thus, the result of the optimization can be further processed by a superordinate system, in particular, the result can be taken into account in a superordinate optimization of enterprise resource planning.

The object is further achieved by a method for optimizing multiple at least partially interlinked production installations and/or processes of a metallurgical installation, in particular over the entire life and/or the entire metallurgical process chain,
wherein each production facility and/or each process can comprise respective associated subinstallations and/or subprocesses,
wherein each production facility and/or each process comprises a separate data management device and each sub-facility and/or subprocess can comprise an optional dedicated data management device,
wherein, in each separate data management device of the production installations and/or processes and the optional dedicated data management devices of the subinstallations and/or subprocesses, the entities of the metallurgical installation that are relevant for the respective part of the production installation and/or process and of the subinstallations and/or subprocesses are identifiable by local identifiers and the local identifiers can be used to retrieve the data of the separate data management devices and of the optional dedicated data management devices that are associated with the related entities of the metallurgical installation,
wherein each entity of the metallurgical installation has an associated global identifier in a central data management device,
wherein the applicable local identifiers of the separate data management devices and the optional dedicated data management devices that are associated with the same entities of the metallurgical installation are associated with each global identifier in the central data management device, and
wherein the optimization of the multiple at least partially interlinked production installations and/or processes involves at least some of the data from the separate data management devices and the optional dedicated data management devices being aggregated and evaluated by means of the global identifiers.

The method is based on an aggregation and evaluation of all available data concerning the multiple production installations and/or processes of a metallurgical installation, including possible subinstallations and/or subprocesses. Data is recorded for each production facility and/or each process and stored in a separate data management device in each case. Furthermore, data can be recorded for each subinstallation and/or subprocess and stored in an optional dedicated data management device. The separate data management devices and the optional dedicated data management devices may have different structures. Furthermore, the entities of the metallurgical installation relevant for the respective part of the production installation location and/or process and the subinstallations and/or subprocesses are identifiable by different local identifiers in the separate data management devices and the optional dedicated data management devices. The data of the separate data management devices and the optional dedicated data management devices associated with the associated entities of the metallurgical installation may be retrieved via the different local identifiers.

Although the data is available and identifiable in the separate data management devices and the optional data management devices, it is only identifiable via the respective local identifiers. With the plurality of production installations and/or processes and possible subinstallations and/or subprocesses, each production installation and/or process would have to have detailed knowledge of the separate data management devices and optional dedicated data management devices of the other production installations and/or processes and subinstallations and/or subprocesses, but this is not economically feasible due to the complexity.

For aggregation and evaluation, the method provides a central data management device, in which each entity of the metallurgical installation has an associated global identifier. This global identifier is associated in the central data management device with the applicable local identifiers of the separate data management devices and the optional dedicated data management devices, which are associated with the same entities of the metallurgical installation. This also comprises a reference to the respective separate data management devices and the optional dedicated data management devices.

By means of the central data management device, it is easy to determine, by means of the global identifier and/or the local identifiers, in which separate data management devices data on an entity of the metallurgical installation are stored. The references to the local identifiers of the separate data management devices and the optional dedicated data management devices can be used to retrieve the corresponding data from the separate data management devices and the optional dedicated data management devices. Based on the total retrieved data from the separate data management devices and the optional dedicated data management devices, the separate production facilities and/or processes of the metallurgical installation can be optimized by aggregating and evaluating the retrieved data.

Based on a local and/or global identifier, the method can be used to determine which other local and/or global identifiers are attached to an entity.

According to one variant, the separate data management devices and the optional dedicated data management devices comprise data on the entities of the metallurgical installation, in particular data relevant to the respective production installation and/or production process or the subinstallation and/or subprocess of the metallurgical installation.

In another variant, the optimization is carried out by a superordinate control system, for optimizing the overall balance of the metallurgical installation, in particular in the areas of maintenance, process control or product quality.

In accordance with an alternative or additional variant, the optimization is carried out by one or more control systems operating independently of one another, for the optimization of a single production installation and/or a single process of the metallurgical installation, wherein at least partially data from the separate data management devices and the optional dedicated data management devices of the other independently operating production installations and/or processes and subinstallations and/or subprocesses are taken into account.

According to one variant, the storage of the data and/or the local identifiers in the separate data management devices and/or optional dedicated data management devices is at least partially carried out in different structures.

In one expedient variant, the separate data management devices and/or optional dedicated data management devices store at least partially data on the same entities of the metallurgical installation.

In accordance with an advantageous variant, the global identifier of the central data management device replaces or supplements the local identifiers of the separate data management devices and/or optional dedicated data management devices. In such variant, the data from the separate data management devices and optional dedicated data management devices can be easily retrieved using the global identifier of the central data management device. This simplifies, for example, the retrieval of data from multiple data management devices, since the respective queries to the separate data management devices and optional data management devices do not have to contain the respective associated local identifiers, but may all contain the global identifier.

According to an expedient variant, information is stored in the central data management device, in which separate data management devices and/or optional dedicated data management devices data on individual entities of the metallurgical installation are stored.

In a further expedient embodiment, the individual separate data management devices and/or optional dedicated data management devices exchange data with one another.

In accordance with one variant, information on relationships between the entities of the metallurgical installation is additionally stored in the central data management device. In particular, the central data management device stores information on different types of relationships between the entities of the metallurgical installation, such as spatial, functional, process or comparable relationships.

According to one preferred variant, the information stored in the central data management device on relationships between the entities of the metallurgical installation forms a network.

In one expedient embodiment, the central data management device maps the relationships between the entities of the metallurgical installation as a graph. For example, the central data management device is designed as a graph database for this purpose, or the graphs are generated at runtime. Thereby, a graph in the sense of the disclosure is a data structure that relates entities to one another via edges. Thus, in the variant, the local identifiers are related to one another by means of graphs via global identifiers. The graphs make it easy to map complex structures of the metallurgical installation. The entities of the metallurgical installation may have a multitude of relationships among themselves and form a complex network, but are still easily represented by the graphs.

By means of the graphs, in particular, the local and/or global identifiers of superordinate and/or subordinate entities can also be determined.

In accordance with an expedient variant, the central data management device can communicate via a communication network to other components of the metallurgical installation, in particular the separate data management devices and/or optional dedicated data management devices.

According to a further variant, the method comprises data input via a graphical user interface of the central data management device.

In a preferred embodiment, an enterprise resource planning system (ERP system) can access the central data management device or the system, as the case may be.

The object is further achieved by a computer program comprising instructions that, when the program is executed by a computer, cause the computer to execute the method according to the disclosure, in particular that the system according to the disclosure executes the method according to the disclosure.

The solution provides a digital microservice with the functions described above, in particular the specified instances, which uniquely identifies entities, for example, by an alphanumeric character string, and is able to map structures of—or relationships between, as the case may be—such entities both instantaneously and in an arbitrarily scalable manner. The microservice thus fulfills the necessary condition of identifiability along with the sufficient condition of knowledge of relationships, with the purpose of enabling targeted data exchange between the digital solutions to be connected along with the derivation of findings. In addition, rapid restructuring to represent application-specific perspectives is possible without losing the unique identification of assets.

### BRIEF DESCRIPTION OF THE DRAWINGS

The invention is explained in more detail below with reference to an exemplary embodiment shown in the figure.

FIG. 1 is a schematic view of an exemplary embodiment of a system for optimizing multiple at least partially interlinked production installations and/or processes of a metallurgical installation.

### DETAILED DESCRIPTION

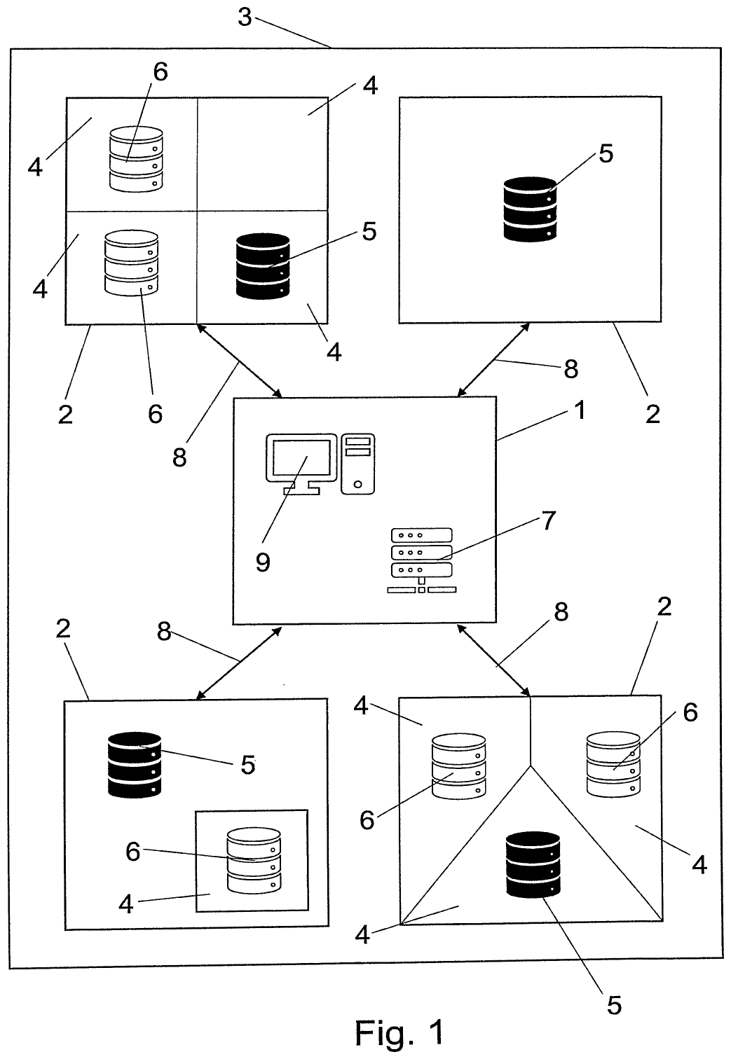

FIG. 1 shows a schematic view of an exemplary embodiment of a system 1 for optimizing multiple at least artially interlinked production installations 2 and/or processes 2 of a metallurgical installation 3, in particular over the entire life and/or the entire metallurgical process chain. In accordance with the exemplary embodiment shown in FIG. 1, the metallurgical installation 3 comprises a total of 4 production installations 2 or processes 2, as the case may be.

Each production installation 2 or process 2, as the case may be, can comprise associated subinstallations 4 and/or subprocesses 4. In this respect, it is also possible for a production installation 2 to have one or more subprocesses 4, or for a process 2 to comprise one or more subinstallations 4. With respect to the possible combinations, the present invention is in no way limited.

Each production installation 2 and/or each process 2 comprises a separate data management device 5, and each subinstallation 4 and/or each subprocess 4 can comprise an optional dedicated data management device 6.

If the production installation 2 or process 2 does not comprise a subinstallation 4 or subprocess 4, such production installation 2 or process 2, as the case may be, comprises a separate data management device 5, as shown in the upper right corner of FIG. 1. If the production installation 2 or process 2, as the case may be, additionally comprises a subinstallation 4 or subprocess 4, such subinstallation 4 or subprocess 4, as the case may be, can comprise an optional dedicated data management device 6, as shown in the lower left corner of FIG. 1. In FIG. 1, the separate data management devices 5 are shown filled in black, while the optional separate data management devices 6 are not shown filled in.

A production installation 2 or process 2, as the case may be, can also comprise multiple subinstallations 4 or subprocesses 4, as shown, for example, in the upper left corner and lower right corner of FIG. 1. In this respect, the present invention is also not limited to one type of hierarchy; rather, the subinstallations 4 or subprocesses 4, as the case may be, may be arranged on the same level or may be hierarchical or mixed. In accordance with the lower right corner of FIG. 1, the production installation 2 or process 2, as the case may be, comprises, for example, three subinstallations 4 or subprocesses 4, as the case may be, which are arranged on the same level. At least one subinstallation 4 or subprocess 4, as the case may be, must have a data management device, which is referred to as a separate data management device 5. The other subinstallations 4 or subprocesses 4, as the case may be, may also have data management devices, which are then referred to as optional dedicated data management devices 6. As shown in the upper left corner of FIG. 1, it is also possible that a subinstallation 4 or subprocess 4, as the case may be, does not have a dedicated data management device 6. This is symbolized by the fourth subinstallation 4 or subprocess 4, as the case may be.

In principle, each production installation 2 or process 2, as the case may be, comprises at least one separate data management device 5, which can also be provided by a subinstallation 4 or subprocess 4, as the case may be. The optional subinstallations 4 and subprocesses 4 may comprise further data management devices, which are referred to as optional dedicated data management devices 6. However, the chosen designation is not to be interpreted restrictively, nor is any possible hierarchy of data management devices among themselves.

In each separate data management device 5 of the production installations 2 and/or processes 2 and the optional dedicated data management devices 6 of the subinstallations 4 and/or subprocesses 4, the entities of the metallurgical installation 3 relevant for the respective part of the production installation location 2 and/or process 2 and the subinstallations 4 and/or subprocesses 4 are identifiable by local identifiers. The data of the separate data management devices 5 and the optional dedicated data management devices 6 assigned to the associated entities of the metallurgical installation 3 can be retrieved via the local identifiers.

The system 1 for optimizing the multiple at least partially interlinked production installations 2 and/or processes 2 comprises a central data management device 7, in which each entity of the metallurgical installation 3 has an associated global identifier. The applicable local identifiers of the separate data management devices 5 and of the optional dedicated data management devices 6 that are associated with the same entities of the metallurgical installation 3 are associated with the respective global identifier in the central data management device 7. The optimization of the multiple at least partially interlinked production installations 2 and/or processes 2 involves at least some of the data from the separate data management devices 5 and the optional dedicated data management devices 6 being aggregated and evaluated by means of the global identifiers.

The separate data management devices 5 and the optional dedicated data management devices 6 comprise data on the entities of the metallurgical installation 3, in particular data relevant to the respective production installation 2 and/or process 2 or the subinstallation 4 and/or subprocess 4 of the metallurgical installation 3.

In accordance with the exemplary embodiment of FIG. 1, the optimization is carried out by a superordinate control system 1, in particular to optimize the overall balance of the metallurgical installation 3. Optimization takes place, for example, in the areas of maintenance, process control or product quality.

Alternatively or additionally, the optimization is carried out by one or more control systems 1 operating independently of one another, for the optimization of a single production installation 2 and/or a single process 2 of the metallurgical installation 3, wherein at least partially data from the separate data management devices 5 and the optional dedicated data management devices 6 of the other independently operating production installations 2 and/or processes 2 and subinstallations 4 and/or subprocesses 4 are taken into account.

The separate data management devices 5 and/or optional dedicated data management devices 6 may have at least partially different structures. The different structures do not have any negative influence, since the data contained in the separate data management devices 5 and/or optional dedicated data management devices 6 can be easily retrieved via the central data management device 7, in particular by means of the global identifier, which refers to the local identifiers of the separate data management devices 5 and/or optional dedicated data management devices 6.

The separate data management devices 5 and/or optional dedicated data management devices 6 may at least partially contain data on the same entities of the metallurgical installation 3. Information is stored in the central data management device 7, in which separate data management devices 5 and/or optional dedicated data management devices 6 data on individual entities of the metallurgical installation 3 are stored. As a result, data stored in multiple separate data management devices 5 and/or optional dedicated data management devices 6 can also be easily retrieved.

Preferably, the global identifier of the central data management device 7 replaces or supplements the local identifiers of the separate data management devices 5 and/or optional dedicated data management devices 6.

Expediently, the individual separate data management devices 5 and/or optional separate data management devices 6 comprise interfaces for the data exchange 8 with one another.

Advantageously, the central data management device 7 additionally contains information on relationships between the entities of the metallurgical installation 3. In particular, the central data management device 7 contains information on different types of relationships between the entities of the metallurgical installation 3. This relates to, for example, spatial, functional, procedural or comparable relationships. The information stored in the central data management device 7 on relationships between the entities of the metallurgical installation 3 may form a network. In this variant, the central data management device maps the relationships between the entities of the metallurgical installation as a graph.

The central data management device 7 is expediently connected via a communication network to other components of the metallurgical installation 3, in particular the separate data management devices 5 and/or optional dedicated data management devices 6. This can be a local communication network or a supra-regional communication network such as the Internet. The invention is not limited with respect to the communication technology used.

Furthermore, the system 1 or the central data management device 7, as the case may be, can comprise a graphical user interface 9 and/or an interface to an enterprise resource planning system (ERP system).

By means of the system 1, a method for optimizing multiple at least partially interlinked production installations 2 and/or processes 2 of a metallurgical installation 3, in particular over the entire life and/or the entire metallurgical process chain, can be carried out,
wherein each production installation 2 and/or process 2 can comprise respective associated subinstallations 4 and/or subprocesses 4,
wherein each production installation 2 and/or each process 2 comprises a separate data management device 5 and each subinstallation 4 and/or each subprocess 4 can comprise an optional separate data management device 6,
wherein, in each separate data management device 5 of the production installations 2 and/or processes 2 and the optional dedicated data management devices 6 of the subinstallations 4 and/or subprocesses 4, the entities of the metallurgical installation 3 that are relevant for the respective part of the production installation 2 and/or process 2 and of the subinstallations 4 and/or subprocesses 4 are identifiable by local identifiers and the local identifiers can be used to retrieve the data of the separate data management devices 5 and of the optional dedicated data management devices 6 that are associated with the related entities of the metallurgical installation 3,
wherein each entity of the metallurgical installation 7 in a central data management device 7 has an associated global identifier,
wherein the applicable local identifiers of the separate data management devices 5 and the optional dedicated data management devices 6 that are associated with the same entities of the metallurgical installation 3 are associated with each global identifier in the central data management device 7, and
wherein the optimization of the multiple at least partially interlinked production installations 2 and/or processes 2 involves at least some of the data from the separate data management devices 5 and the optional dedicated data management devices 6 being aggregated and evaluated by means of the global identifiers.

The separate data management devices 5 and the optional dedicated data management devices 6 comprise data on the entities of the metallurgical installation 3, in particular data relevant to the respective production installation 2 and/or process 2 or the subinstallation 4 and/or subprocess 4 of the metallurgical installation 3. The separate data management devices 5 and/or optional dedicated data management devices 6 may at least partially store data on the same entities of the metallurgical installation 3. Preferably, information is stored in the central data management device 7, in which separate data management devices 5 and/or optional dedicated data management devices 6 data on individual entities of the metallurgical installation 3 are stored.

In accordance with the system 1 of FIG. 1, the optimization is carried out by a superordinate control system 1, for optimizing the overall balance of the metallurgical installation 3, in particular in the areas of maintenance, process control or product quality. Alternatively or additionally, the optimization is carried out by one or more control systems 1 operating independently of one another, for the optimization of a single production installation 2 and/or a single process 2 of the metallurgical installation 3, wherein at least partially data from the separate data management devices 5 and the optional dedicated data management devices 6 of the other independently operating production installations 2 and/or processes 2 and subinstallations 4 and/or subprocesses 4 are taken into account.

The storage of the data and/or the local identifiers in the separate data management devices 5 and/or optional dedicated data management devices 6 can be carried out at least partially in different structures.

Expediently, the global identifier of the central data management device 7 replaces or supplements the local identifiers of the separate data management devices 5 and/or optional dedicated data management devices 6.

The individual separate data management devices 5 and/or optional separate data management devices 6 can exchange data with one another.

Advantageously, the central data management device 7 additionally stores information on relationships between the entities of the metallurgical installation 3, in particular information on different types of relationships between the entities of the metallurgical installation 3. The relationships concern, for example, spatial, functional, procedural or comparable relationships. The information stored in the central data management device 7 on relationships between the entities of the metallurgical installation 3 may form a network, in particular with any structure. In this variant, the central data management device maps the relationships between the entities of the metallurgical installation as a graph.

The central data management device 7 is further designed to communicate via a communication network with other components of the metallurgical installation 3, in particular the separate data management devices 5 and/or optional dedicated data management devices 6.

The method can also comprise data input via a graphical user interface 9 of the central data management device 7.

For further use of the optimization results, an enterprise resource planning system (ERP system) can access the central data management device 7 or the system, as the case may be.

### LIST OF REFERENCE SIGNS

1 System

2 Production installation/process

3 Metallurgical installation

4 Subinstallation/subprocess

5 Separate data management device

6 Optional dedicated data management device

7 Central data management device

8 Data exchange

9 Graphical user interface

1-18. (canceled)

19. A system (1) for optimizing multiple at least partially interlinked production installations (2) and/or processes (2) of a metallurgical installation (3), in particular over an entire life and/or an entire metallurgical process chain,
wherein each production installation (2) and/or each process (2) can comprise respective associated subinstallations (4) and/or subprocesses (4),
wherein each production installation (2) and/or each process (2) comprises a separate data management device (5) and each subinstallation (4) and/or each subprocess (4) can comprise an optional dedicated data management device (6),
wherein, in each separate data management device (5) of the production installations (2) and/or processes (2) and the optional dedicated data management devices (6) of the subinstallations (4) and/or subprocesses (4), entities of the metallurgical installation (3) that are relevant for the respective part of the production installation (2) and/or process (2) and of the subinstallations (4) and/or subprocesses (4) are identifiable by local identifiers and the local identifiers can be used to retrieve data of the separate data management devices (5) and of the optional dedicated data management devices (6) that are associated with the related entities of the metallurgical installation (3),
wherein the system (1) for optimizing the multiple at least partially interlinked production installations (2) and/or processes (2) comprises a central data management device (7) in which each entity of the metallurgical installation (3) has an associated global identifier,
wherein the applicable local identifiers of the separate data management devices (5) and of the optional dedicated data management devices (6) that are associated with the same entities of the metallurgical installation (3) are associated with the respective global identifier in the central data management device (7), and
wherein the optimization of the multiple at least partially interlinked production installations (2) and/or processes (2) involves at least some of the data from the separate data management devices (5) and the optional dedicated data management devices (6) being aggregated and evaluated by means of the global identifiers.

20. The system (1) according to claim 19,
wherein the optimization is carried out by a superordinate control system (1) for optimizing an overall balance of the metallurgical installation (3) in areas of maintenance, process control, or product quality.

21. The system (1) according to claim 19,
wherein the optimization is carried out by one or more control systems (1) operating independently of one another, for the optimization of a single production installation (2) and/or a single process (2) of the metallurgical installation (3),
wherein at least partially data from the separate data management devices (5) and the optional dedicated data management devices (6) of the other independently operating production installations (2) and/or processes (2) and subinstallations (4) and/or subprocesses (4) are taken into account.

22. The system (1) according to claim 19,
wherein the global identifier of the central data management device (7) supplements the local identifiers of the separate data management devices (5) and/or optional dedicated data management devices (6).

23. The system (1) according to claim 19,
wherein information is stored in the central data management device (7) identifying in which separate data management devices (5) and/or optional dedicated data management devices (6) data on individual entities of the metallurgical installation (3) are stored.

24. The system (1) according to claim 19,
wherein the central data management device (7) additionally contains information on relationships between the entities of the metallurgical installation (3).

25. The system (1) according to claim 24,
wherein the central data management device (7) contains information on spatial, functional, process or comparable relationships between the entities of the metallurgical installation (3).

26. The system (1) according to claim 24,
wherein the information stored in the central data management device (7) on relationships between the entities of the metallurgical installation (3) forms a network.

27. A method for optimizing multiple at least partially interlinked production installations (2) and/or processes (2) of a metallurgical installation (3), in particular over an entire life and/or an entire metallurgical process chain,
wherein each production installation (2) and/or process (2) can comprise respective associated subinstallations (4) and/or subprocesses (4),
wherein each production installation (2) and/or each process (2) comprises a separate data management device (5) and each subinstallation (4) and/or each subprocess (4) can comprise an optional separate data management device (6),
the method comprising:
identifying, in each separate data management device (5) of the production installations (2) and/or processes (2) and the optional dedicated data management devices (6) of the subinstallations (4) and/or subprocesses (4), the entities of the metallurgical installation (3) that are relevant for the respective part of the production installation (2) and/or process (2) and of the subinstallations (4) and/or subprocesses (4) by local identifiers and using the local identifiers to retrieve data of the separate data management devices (5) and of the optional dedicated data management devices (6) that are associated with the related entities of the metallurgical installation (3);
associating each entity of the metallurgical installation (7) in a central data management device (7) with an associated global identifier;
associating the applicable local identifiers of the separate data management devices (5) and the optional dedicated data management devices (6) that are associated with the same entities of the metallurgical installation (3) with each global identifier in the central data management device (7); and
aggregating and evaluating, for the optimization of the multiple at least partially interlinked production installations (2) and/or processes (2), at least some of the data from the separate data management devices (5) and the optional dedicated data management devices (6) by means of the global identifiers.

28. The method according to claim 27,
wherein the optimization is carried out by a superordinate control system (1) for optimizing an overall balance of the metallurgical installation (3) in areas of maintenance, process control, or product quality.

29. The method according to claim 27,
wherein the optimization is carried out by one or more control systems (1) operating independently of one another, for the optimization of a single production installation (2) and/or a single process (2) of the metallurgical installation (3),
wherein at least partially data from the separate data management devices (5) and the optional dedicated data management devices (6) of the other independently operating production installations (2) and/or processes (2) and subinstallations (4) and/or subprocesses (4) are taken into account.

30. The method according to claim 27,
wherein the global identifier of the central data management device (7) supplements the local identifiers of the separate data management devices (5) and/or optional dedicated data management devices (6).

31. The method according to claim 27,
wherein information is stored in the central data management device (7), identifying in which separate data management devices (5) and/or optional dedicated data management devices (6) data on individual entities of the metallurgical installation (3) are stored.

32. The method according to claim 27,
wherein the central data management device (7) additionally stores information on relationships between the entities of the metallurgical installation (3).

33. The method according to claim 32,
wherein information on spatial, functional, procedural, or comparable relationships between the entities of the metallurgical installation (3) is stored in the central data management device (7).

34. The method according to claim 32,
wherein the information stored in the central data management device (7) on relationships between the entities of the metallurgical installation (3) forms a network.

35. The method according to claim 27,
wherein an enterprise resource planning system accesses the central data management device (7).
